(19) United States
(12) Patent Application Publication
(10) Pub. No.: US 2002/0063230 A1
(43) Pub. Date: May 30, 2002

(54) Manually-operated valve particularly for gas, with means for limiting the opening stroke of the actuation handwheel

(76) Inventor: Davide Cavagna, Ponte S. Marco di Calcinato (IT)

Correspondence Address: CANTOR COLBURN, LLP, 55 GRIFFIN ROAD SOUTH, BLOOMFIELD, CT, 06002

(21) Appl. No.: 09/912,113

(22) Filed: Jul. 24, 2001

(30) Foreign Application Priority Data
Nov. 29, 2000 (IT) MI2000A002578

(51) Int. Cl. F16K 35/00

(52) U.S. Cl. 251/284

(57) ABSTRACT

A manually-operated valve particularly for gas, with elements for limiting the opening stroke of an actuation handwheel, which comprises a valve body which internally forms a gas passage duct being controlled by a flow control element which can be actuated by a handwheel which can perform a translational motion by turning. Elements for limiting the opening stroke of the handwheel are further provided. The stroke limiting elements comprise a locking element which can move substantially at right angles to the axis of the rotation thread of the handwheel, the locking element engaging, at an opening stroke limit of the handwheel, an abutment for stopping the rotation of the handwheel.

### BACKGROUND OF THE INVENTION

The present invention relates to a manually-operated valve particularly for gas, with means for limiting the opening stroke of the actuation handwheel.

It is known that manually-operated gas valves substantially have a valve body which internally forms a gas passage duct which is controlled by a flow control element being actuated by means of a handwheel which performs a translational motion by rotating, i.e., performs its axial translational motion by way of a threaded coupling provided by a female thread, formed inside the valve body, and by a male thread provided on the handwheel.

In current embodiments, in order to prevent the accidental extraction of the handwheel from the valve body during opening of the valve, a retention element is provided which is accommodated inside the valve body and engages a shoulder provided on the handwheel.

When blocking occurs, i.e., when the shoulder engages the retention element, an axial thrust component is produced which causes considerable friction on the worm between the female thread of the valve body and the male thread of the handwheel; in some cases, such friction can lead to jamming of the valve, causing problems in subsequent actuation of the handwheel.

### SUMMARY OF THE INVENTION

The aim of the invention is to eliminate the above mentioned drawbacks, by providing a manually-operated valve particularly for gas, with stroke limiting means, in which it is possible to stop the rotation of the handwheel without generating axial components which produce the considerable friction on the worms that leads to jamming of the valve.

Within this aim, an object of the invention is to provide a valve with stroke limiting means in which it is possible to achieve automatic engagement and disengagement of the stroke limiting means without producing friction in the actuation of the handwheel of the valve.

Another object of the present invention is to provide a valve which thanks to its particular constructive characteristics is capable of giving the greatest assurances of reliability and safety in use.

Another object of the present invention is to provide a valve which can be easily obtained starting from commonly commercially available elements and materials and is further competitive from a merely economical point of view.

This aim and these and other objects which will become better apparent hereinafter are achieved by a manually-operated valve particularly for gas, with means for limiting the opening stroke of the actuation handwheel, comprising a valve body which internally forms a gas passage duct being controlled by a flow control element which can be actuated by means of a handwheel which can perform a translational motion by turning, means for limiting the opening stroke of said handwheel being further provided, characterized in that said stroke limiting means comprise at least one locking element which can move substantially at right angles to an axis of a rotation thread of said handwheel, said at least one locking element engaging, at an opening stroke limit of said handwheel, an abutment for stopping rotation of said handwheel.

### BRIEF DESCRIPTION OF THE DRAWINGS

Further characteristics and advantages of the invention will become better apparent from the description of some preferred but not exclusive embodiments of a manually-operated valve particularly for gas, with means for limiting the opening stroke of the actuation handwheel, illustrated only by way of non-limitative example in the accompanying drawings, wherein:

FIG. 1 is a schematic partially sectional view of a valve in the closed position;

FIG. 2 is a sectional view of a detail of the valve, illustrating the insertion of the locking element that prevents extraction of the handwheel;

FIG. 3 is a sectional view, taken along the line III-III of FIG. 1;

FIG. 4 is a sectional view, taken along the line IV-IV of FIG. 2;

FIG. 5 is a sectional view of a valve with a different embodiment of the locking element;

FIG. 6 is a sectional view, taken along the line VI-VI of FIG. 5;

FIG. 7 is a sectional view of a valve in which the locking element is supported by the handwheel;

FIG. 8 is a sectional view, taken along the line VIII-VIII of FIG. 7;

FIG. 9 is a constructive variation, with a locking element which surrounds the handwheel and is supported by it;

FIG. 10 is a sectional view, taken along the line X-X of FIG. 9;

FIG. 11 is a sectional view, taken along a substantially vertical diametrical plane, of another embodiment of the valve in which the locking element associated is with the knob of the handwheel;

FIG. 12 is a sectional view, taken along the line XII-XII of FIG. 11;

FIG. 13 is a sectional view, taken along a substantially vertical diametrical plane, of an embodiment in which the locking element is constituted by a coiled locking spring;

FIG. 14 is a sectional view, taken along the line XIV-XIV of FIG. 13.

### DESCRIPTION OF THE PREFERRED EMBODIMENTS

With reference to the figures, the manually-operated valve particularly for gas, with means for limiting the opening stroke of the actuation handwheel, generally designated by the reference numeral 1, comprises a valve body 2 having a mouth 3 for the connection of a bottle of gas and the like and a mouth 4 for dispensing the gas. Inside the valve body 2 a duct 5 is provided for connection between the mouth 3 and the mouth 4 being controlled by a flow control element 10 which can move hermetically in a chamber 11 formed in the valve body and is actuated by a handwheel 15 which can perform a translational motion by turning.

In greater detail, the handwheel has a shank 16 being arranged inside the valve body and has a male thread 17 which engages a female thread 18 formed in the chamber 11.

The shank 16 is connected to a knob 19 which is external to the valve body 2.

Means for limiting the opening stroke are provided on the handwheel 15 and limit the stroke of the handwheel in order to prevent its extraction.

The stroke limiting means comprise at least one locking element which can move substantially at right angles to the axis of the handwheel rotation thread.

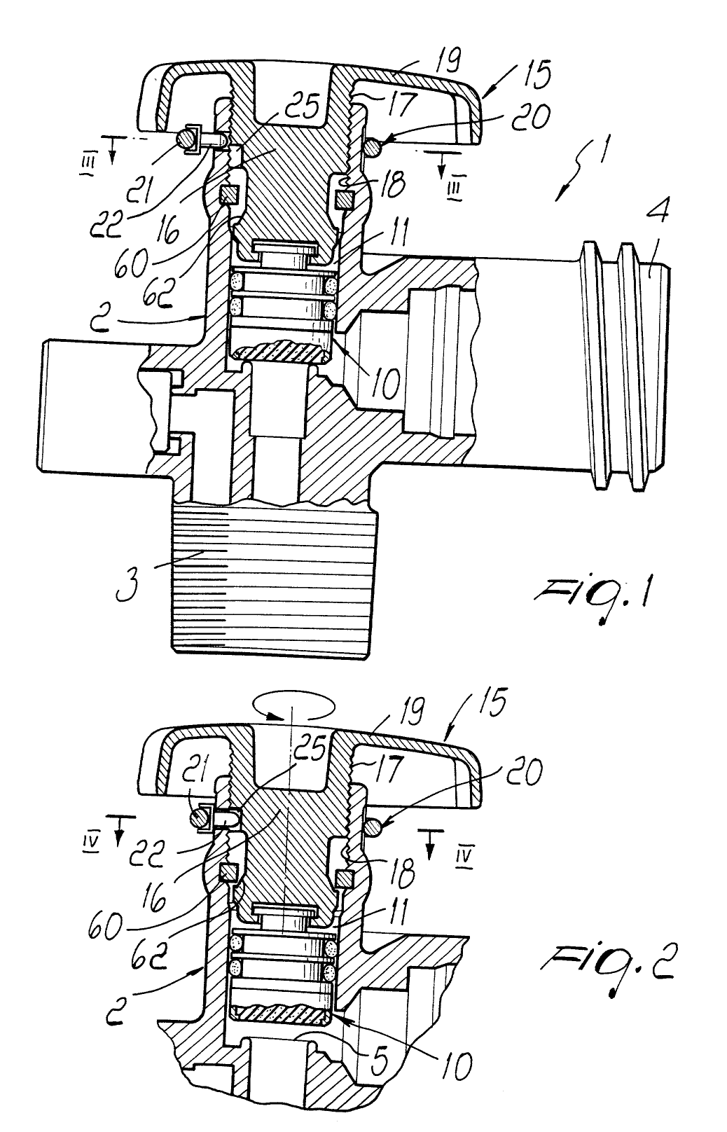

With reference to FIGS. 1 to 4, the locking element, generally designated by the reference numeral 20, has an elastic ring 21 which externally surrounds the valve body and acts on a locking pin 22 which can move radially with respect to the chamber in which the shank 16 of the handwheel can perform a translational motion.

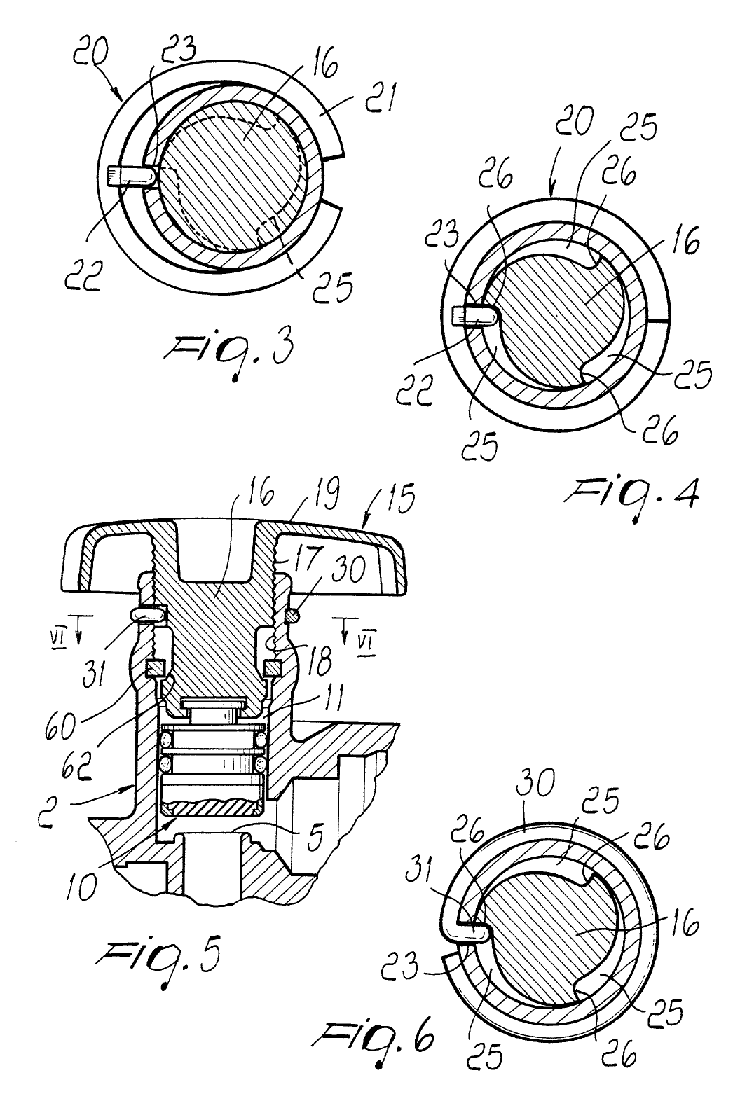

The shank of the handwheel, as shown more clearly in FIGS. 3 and 4, is provided along its circumference with recesses 25 which gradually increase in depth and define, at the deepest end, an abutment 26 for stopping rotation by engaging the locking pin 22.

With the described arrangement, the locking pin is pushed elastically in a radial direction by the elastic ring and performs its insertion when the hole 23, in which it is slidingly supported, is located in front of a recess 25, allowing its insertion.

The engagement between the locking pin 22 and the abutment 26 blocks the rotation of the handwheel 15 in the opening direction without however creating any forcing in an axial direction.

According to a different embodiment, which is conceptually similar and is shown in FIGS. 5 and 6, the locking element has an annular element 30 which ends with a locking pin 31 which also can slide in a radial direction and is accommodated in a hole 23 formed in the valve body 2.

As in the preceding example, there are recesses 25 with the corresponding abutment 26.

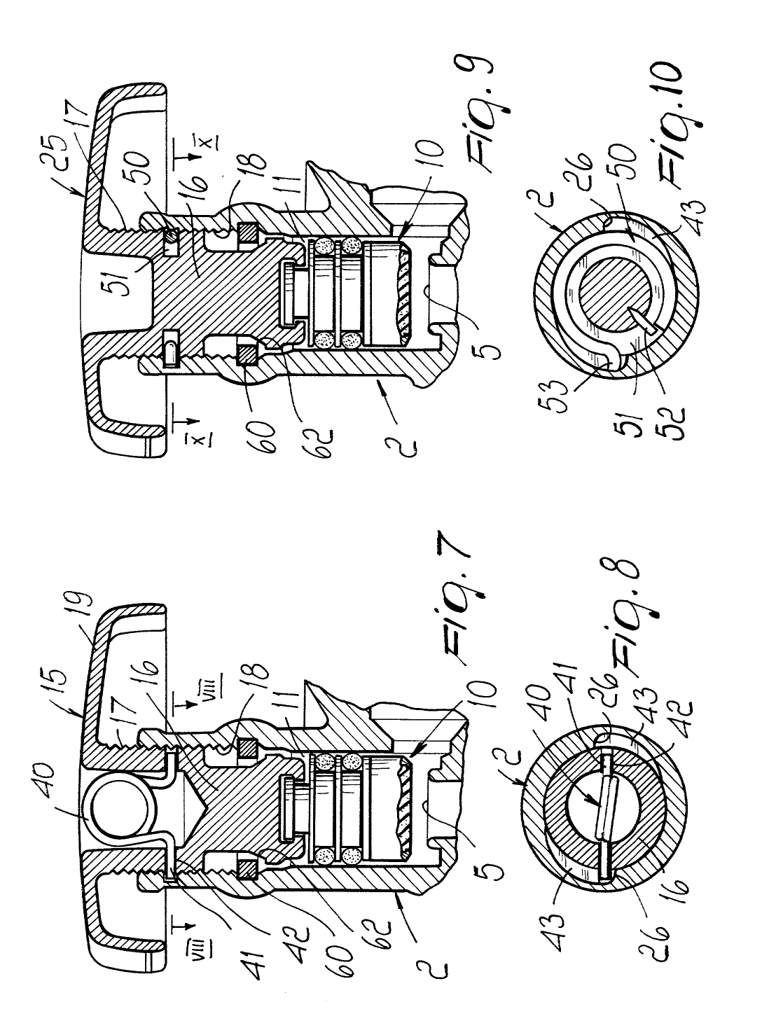

According to a kinematically reversed embodiment, the locking ring can be fitted on the handwheel, as shown in FIGS. 7 and 8.

In this case, there is a pin spring 40 which is provided with two locking ends 41 which can slide in a radial direction with respect to radial holes 42 provided in the handwheel and can be inserted in recesses 43 formed correspondingly on the internal surface of the valve body. The recesses 43 gradually increase in depth and have, at their deeper ends, an abutment which is again designated by the reference numeral 26.

FIGS. 9 and 10 illustrate a locking element which is fitted on the handwheel 15 and is provided by means of an internal ring 50 which lies circumferentially in a groove 51 formed in the handwheel.

In the groove there is a radial stop element 52 for one end of the internal ring having at its other end a locking tip 53 which enters a recess, again designated by the reference numeral 43, which gradually increases in depth and has the abutment 26 at its deeper end.

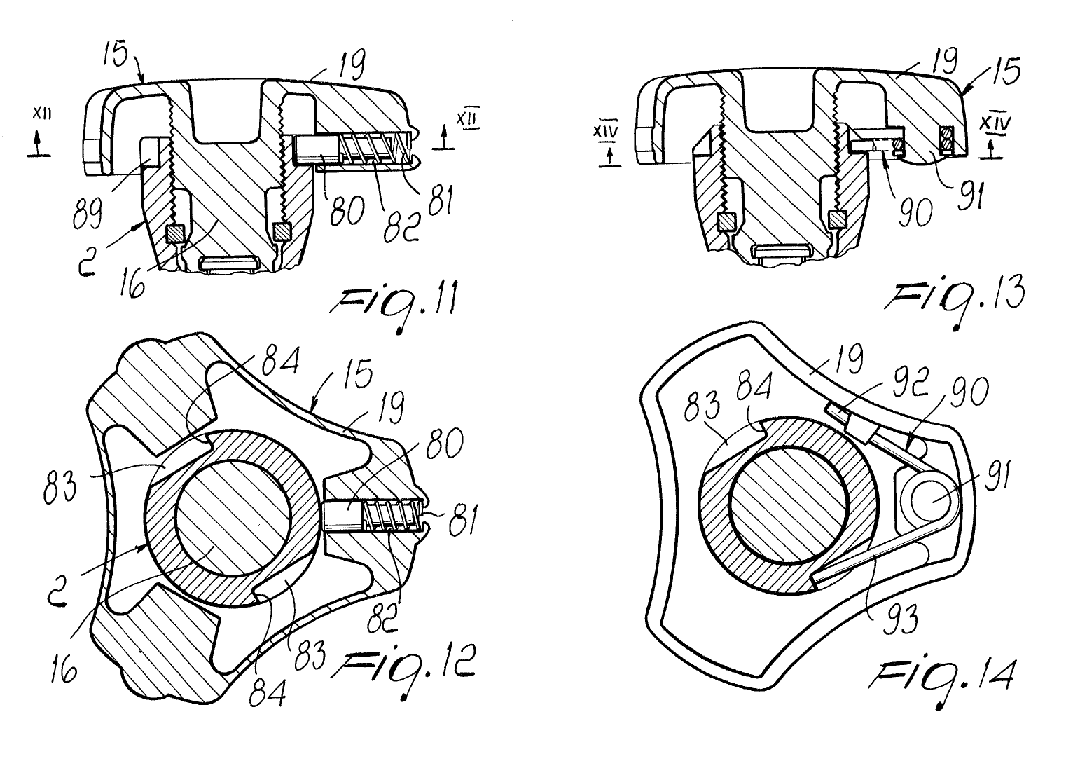

With reference to FIGS. 11 and 12, another embodiment is illustrated being based on the same innovative concept and in which the locking element is supported by the handwheel.

In the specific embodiment, the locking element is constituted by a piston 80 being pushed by a helical pusher spring 81 which is accommodated in a slot 82 which is formed inside the knob 19.

The piston 80 is pushed against the body 2 of the valve in the region where the shank 16 of the handwheel 15 is inserted.

In this region, the body 2 is provided with outer recesses 83 which gradually increase in depth along its circumference and form, at the deeper end, an external abutment 84 against which the piston 80 engages, locking the rotation of the knob in the extraction direction.

With reference to FIGS. 13 and 14, another embodiment is illustrated in which the locking element is associated with the knob 19 of the handwheel 15.

The locking element is provided by means of a pin spring 90 supported by a protrusion 91 formed on the knob 19 and provided with a first arm 92 which abuts against the internal surface of the knob and a second arm 93 which engages the external recesses, again designated by the reference numeral 83.

In this embodiment, the pin spring 90 has excellent resistance to the unscrewing torque produced by the load applied axially in an upward region with respect to the spring.

The embodiments illustrated in FIGS. 11 to 14 are particularly advantageous, since in practice they allow to avoid substantially modifying the manufacture of the existing valve by adopting a few structural modifications on the knob of the handwheel and on the outer surface of the valve body.

To complete the assembly, it is noted that for safety reasons it is possible to maintain the traditional locking ring, designated by the reference numeral 60, which engages by abutment against a shoulder 62 formed on the handwheel.

The arrangement is such that engagement between the shoulder 62 and the locking ring 60 is provided only in case of failure of the locking performed by the locking element that is movable at right angles to the axis of the rotation thread of the handwheel, i.e., the axis formed by the male thread 17 provided on the handwheel and the female thread 18 provided on the surface of the chamber formed inside the valve body.

With the described arrangement, therefore, the locking element, by performing a translational motion in a radial direction, does not generate axial components on the handwheel which might lead to jamming of the rotation of the handwheel due to the friction generated on the rotation thread; furthermore, the described arrangement allows to achieve automatic engagement and disengagement of the locking element without producing force components which might lead to jamming.

The invention thus conceived is susceptible of numerous modifications and variations, all of which are within the scope of the appended claims.

All the details may further be replaced with other technically equivalent elements.

In practice, the materials used, as well as the contingent shapes and dimensions, may be any according to requirements.

The disclosures in Italian Patent Application No. MI2000A002578 from which this application claims priority are incorporated herein by reference.

What is claimed is:

1. A manually-operated valve particularly for gas, with means for limiting the opening stroke of an actuation handwheel, comprising a valve body which internally forms a gas passage duct being controlled by a flow control element which can be actuated by means of a handwheel which can perform a translational motion by turning, means for limiting the opening stroke of said handwheel being further provided, wherein said stroke limiting means comprise at least one locking element which can move substantially at right angles to an axis of a rotation thread of said handwheel, said at least one locking element engaging, at an opening stroke limit of said handwheel, an abutment for stopping rotation of said handwheel.

2. The valve according to claim 1, wherein said locking element comprises an elastic ring which externally surrounds the valve body and acts on a locking pin which can move radially with respect to a chamber in which a shank of said handwheel can perform a translational motion, said shank being circumferentially provided with recesses which gradually increase in depth and form said abutment at a deepest end.

3. The valve according to claim 1, wherein said locking element comprises an annular element which ends with a locking pin which can slide in a radial direction and is accommodated in said hole formed in said valve body, said recesses being formed in a shank of the handwheel and forming, at one end, said abutment.

4. The valve according to claim 1, wherein said locking element comprises a pin spring which is supported inside the shank of said handwheel, said pin spring having at least one locking end which can slide in a radial direction in radial holes provided in a shank of the handwheel, said at least one end being insertable in recesses which are formed correspondingly in the internal surface of said valve body and gradually increase in depth, said abutment being formed at a deepest end of said recesses.

5. The valve according to claim 1, wherein said locking element comprises an internal ring which lies circumferentially in a groove formed in a shank of the handwheel, a radial retention element being provided in said groove for an end of said internal ring, said internal ring having, at another end, a locking tip which can be inserted in a recess which gradually increases in depth and has said abutment at a deepest end thereof, said recess being formed in said valve body.

6. The valve according to claim 1, wherein said locking element comprises a piston which is pushed elastically and is supported by a knob of said handwheel, said piston being engageable in external recesses which are formed in an outer surface of said valve body, gradually increase in depth and end, at one end, with an external abutment.

7. The valve according to claim 1, wherein said locking element moves on a plane which is substantially perpendicular to the axis of the rotation thread of said handwheel.

8. The valve according to claim 1, wherein said locking element comprises a locking spring which is supported by a protrusion formed by a knob of said handwheel, said locking spring forming a first arm which can engage said knob and a second arm which can engage external recesses which gradually increase in depth and are formed by said valve body, said external recesses ending with an abutment.
